(19) United States
(12) Patent Application Publication
(10) Pub. No.: US 2011/0050132 A1
(43) Pub. Date: Mar. 3, 2011

(54) AREA BASED LIGHTING CONTROL SYSTEM INCLUDING LOCAL LUMINAIRE CONTROL

(75) Inventors: Christofher Daniel Charles Hooijer, Helmond (NL); Bram Francois Joosen, Eindhoven (NL); Johannes Weda, Nijmegen (NL)

(73) Assignee: KONINKLIJKE PHILIPS ELECTRONICS N.V., Eindhoven (NL)

(21) Appl. No.: 12/990,655

(22) PCT Filed: Apr. 30, 2009
(86) PCT No.: PCT/IB2009/051753

§ 371 Date: Nov. 2, 2010

(30) Foreign Application Priority Data
May 7, 2008 (EP) 08103845.7

(51) Int. Cl. H05B 37/02; G06F 3/041

(52) U.S. Cl. 315/297; 345/173; 178/18.03

(57) ABSTRACT

The invention relates to local luminaire control in an area based lighting control system. A basic idea of this invention is to use a soft switch assigned to one or more luminaries of an area based lighting control system to locally control the luminaire/ies, wherein the soft switch is adapted for generating an appropriate signal for the area based lighting control system, that puts the luminaire/ies in the desired state. An embodiment of the invention provides an area based lighting control system (10), comprising several lamps (12) provided for illuminating an area, a control device (14) for controlling one or more of the several lamps responsive to received control signals (16, 18, 20), and at least one soft switch (22, 24) assigned to one or more lamps (26, 28) and being adapted to sense user touches and to signal sensed user touches by means of sending a control signal (16, 18) to the control device (14), which is configured to control the lamps (26, 28), to which the soft switch is assigned, responsive to the received control signal. This allows a local luminaire control which is integrated in the central lighting control of an area based lighting control system.

### FIELD OF THE INVENTION

The invention relates to local luminaire control in an area based lighting control system.

### BACKGROUND OF THE INVENTION

An area based lighting control system allows control of a multitude of lamps and groups of lamps to illuminate certain areas. Currently a lot of area based lighting control systems exist. For transmitting control signals, these systems use communication technologies such as Power Line Communication (existing cables, e.g. X10), Radio Communication (wireless, e.g. Zigbee, Z-wave), Infrared Communication (wireless line-of sight), Digital Communication (wired, e.g. DALI) and Analogue Communication (wired, e.g. 1-10V). On the other hand, also a lot of local luminaire control means such as hard switches exists, for example a cord switch, a cord dimmer, a luminaire rocker switch, or a 3-way turnable knob.

Many existing area based lighting control systems offer wall and remote controls as area lighting controls. In order to operate (on/off/dim) the lamps locally, these area lighting controls must be usually used. Some area based lighting control systems also allow the use of the local luminaire control means to individually control the lamps. In this case a hard switch on the luminaire is normally in the ON position, and the lamp is controlled by an area lighting control, for example a remote control of the lighting control system. When a user wants to individually control the luminaire, the hard switch on the luminaire must be toggled for a few seconds to the OFF position and then back to the ON position. This causes the lamp to toggle its state: turn off, when it was on, or turn on, when it was off.

However, these means for local luminaire control may create some hassle. If local luminaire control should be done by using a remote control, users often complain about the complexity and/or ‘lost’ remotes and/or empty batteries. Of course the problem with using a hard switch is that once a user switched off the lamp the user cannot use one of the other remote controllers to switch it back on again. The option to toggle the switch for a few seconds to the OFF position as described above is clearly not intuitive: people tend to forget to turn the switch to the ON position and, as a consequence, the lamp is no longer controlled by the lighting control. Thus, a hard switch for local luminaire control in an area based lighting control system tends to lead to problems and errors in user operation.

### SUMMARY OF THE INVENTION

It is an object of the present invention to provide an area based lighting control system with an improved local luminaire control.

The object is solved by the independent claims. Further embodiments are shown by the dependent claims.

A basic idea of this invention is to use a soft switch assigned to one or more luminaries of an area based lighting control system to locally control the luminaire/ies, wherein the soft switch is adapted for generating an appropriate signal for the area based lighting control system that puts the luminaire/ies in the desired state. This creates a local luminaire control which may be integrated in the control concept of an area based lighting control system, so that typical user operation problems with local luminaire control in an area based lighting control system such as the above described may be overcome. In contrast to existing solutions and systems, the invention offers a user a local luminaire control which is intuitive to operate and fully integrated in an area based lighting control system. The term “soft switch” should be understood in contrast to the traditional and known hard switches, installed at or integrated into lamps and as described above, in the context of the present invention. A soft switch in the context of the invention is a device which is adapted to sense user touches and to react on user touches, in contrast to a hard switch, which only react on performing a “hard” operation such as mechanically operating a switch. A soft switch electronically senses a user touch and does not require a mechanic operation by a user.

An embodiment of the invention provides an area based lighting control system, comprising
several lamps provided for illuminating an area,
a control device for controlling one or more of the several lamps responsive to received control signals, and
at least one soft switch assigned to one or more lamps and being adapted to sense user touches and to signal sensed user touches by means of sending a control signal to the control device, which is configured to control the lamps, to which the soft switch is assigned, responsive to the received control signal.

A soft switch assigned to one or more lamps means that the soft switch is primarily provided to control the assigned lamps, and usually no other lamps. A comfortable local luminaire control may achieved by the integration of the control of the lamp control in the lighting control system, in contrast to a local control via traditional hard switches of the lamps, which is not at all integrated in the lighting control system and, therefore, may cause hassle for users operating the lighting control system.

The soft switch may in an embodiment of the invention comprise a touch dimmer interface integrated in a lamp or implemented as further control device of the system. The touch dimmer interface integrated in the lamp allows users to easily and locally control lamps, for example to switch on a lamp in the neighborhood, or to dim a lamp. The implementation as further control device offers users a greater flexibility in arranging the soft switch, for example placing the soft switch at a user preferred location, such as the user's desk.

According to a further embodiment of the invention, the soft switch may comprise a communication device for a wired and/or wireless communication with a control device, wherein the communication device is adapted to communicate by means of one or more of the following communication methods: Power Line Communication; Radio Communication; Infrared Communication; wired Digital Communication; wired Analogue Communication.

In an embodiment of the system, the control signal sent by the soft switch may contain an identification of the soft switch, which sent out the control signal, in order to allow the receiving control device to identify the sending soft switch. This may be advantageous when the control signal is sent via a wireless communication method, since several control devices may then receive the sent control signal and each receiving control device may determine whether the identification of the soft switch contained in the control signal matches identifications of soft switches stored in the control devices.

In a further embodiment of the system, the control signal sent by the soft switch may contain an identification of the control device, to which the control signal is sent. Thus, each control device, which receives the control signal, may quickly determine, whether it is addressed by the control signal.

The control signal sent by the soft switch may contain in a further embodiment of the invention a dimming value of the lamps being assigned to the soft switch. For example, the control signal may contain the length of a user touch of the soft switch, which may correspond to the dimming value. Also, the soft switch may be adapted so that a touching of the soft switch may result in looping through several dimming states. For example, an algorithm implemented in the soft switch and processing the user touches may loop through the states O-75% dimming level-50% dimming level-25% dimming level-OFF. Thus, when the user ends touching the soft switch, the algorithm may generate the control signal containing the actual loop state.

The assignment of lamps to a soft switch may be in an embodiment of the invention programmed in the soft switch and/or in a control device. Thus, the assignment must not be transmitted from a further device, for example a central controller of the lighting system, which contains the entire configuration of the lighting system including the assignments of soft switches to lamps. Also, a later installation of a soft switch in the lighting system may be easier, since the assignment of lamps may be programmed into the soft switch, or in the control device, with which the later installed soft switch should communicate.

A further embodiment of the invention relates to a lamp being adapted for usage with a system of the invention and comprising a soft switch being assigned to the lamp. The lamp may be for example a floor lamp or a table lamp, which may be integrated in an area based lighting system be means of the soft switch and intuitively operated by users.

In a further embodiment of the invention, at least a part of the lamp may be made of metal, and this part forms a touch sensitive part of the soft switch. This allows integrating the soft switch seamlessly in the design of the lamp.

The lamp may comprise in an embodiment of the invention an integrated electronic, which is adapted to measure a tiny leak current, which flows during a user touch of the touch sensitive part, and to generate and send out a control signal, when the measured tiny leak current exceeds a predetermined threshold.

The lamp may comprise in a further embodiment of the invention an integrated electronic, which is adapted to measure the capacitance of the touch sensitive part and to generate and send out a control signal, when the measured capacitance exceeds a predetermined threshold.

The invention provides in a further embodiment a control device being adapted for usage with a system of the invention and to receive control signals from a soft switch and to control the lamps, to which the soft switch is assigned, responsive to the received control signal. The device may be in an embodiment of the invention a dimmer adapted for controlling several lamps.

Furthermore, the invention provides in an embodiment a soft switch being adapted for usage with a system of the invention and to sense user touches and to signal sensed user touches by means of sending a control signal to a control device, which is configured to control the lamps, to which the soft switch is assigned, responsive to the received control signal. The soft switch may be implemented as separate device, which may be for example switched between the power supply and lamp in order to be locally arranged close to the lamp, to which it is assigned. Thus, only one power connection is required for supplying the soft switch and the lamp. Or the soft switch may be located in an area, which is illuminated by several lamps, to which the soft switch is assigned.

The soft switch may comprise a touch dimmer interface being adapted for allowing a user to control a dimming of local luminaire, according to an embodiment of the invention. The touch dimmer interface may contain for example sliding bars, which allow a user to intuitively dim the lamp or lamps, to which the soft switch is assigned.

These and other aspects of the invention will be apparent from and elucidated with reference to the embodiments described hereinafter.

The invention will be described in more detail hereinafter with reference to exemplary embodiments. However, the invention is not limited to these exemplary embodiments.

### BRIEF DESCRIPTION OF THE DRAWINGS

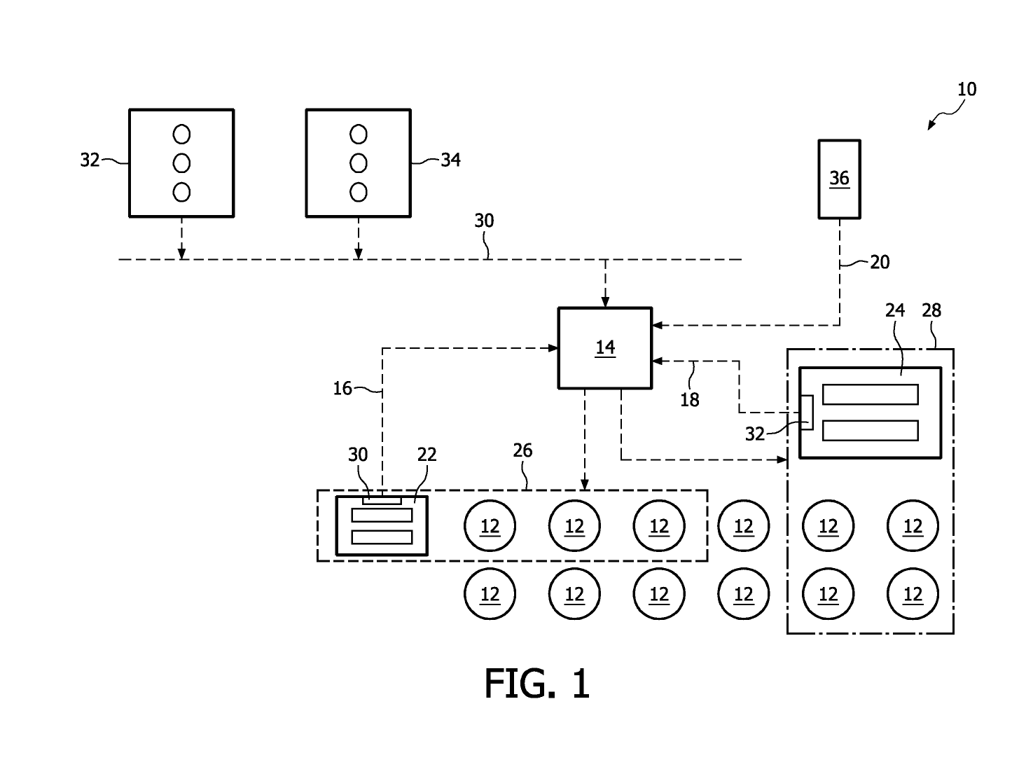

The only FIG. 1 shows a block diagram of an embodiment of an area based lighting control system including local luminaire control according to the invention.

### DETAILED DESCRIPTION OF EMBODIMENTS

The only FIG. 1 shows an area based lighting control system 10 comprising several lamps 12, which are controlled by a dimmer 14, which serves as control device for the lamps. The dimmer 14 powers the lamps 12, i.e. controls the power supply of the lamps 12 and, thus, allows switching lamps 12 on or off or dimming lamps 12. The dimmer 14 is also connected to a bus 30 of the lighting system. The bus 30 connects the dimmer 14 with wall controllers 32 and 34, which are installed near the lamps 12, which they control, typically integrated in the wall of a room. The wall controllers 32 and 34 allow a user to activate and to dim the lamps 12 by pressing a button of the wall controller 32 or 34. The user may also control the lamps 12 via a remote control 36 of the lighting control system 10, which sends signals to the dimmer 14 via a wireless transmission, typically via radio or infrared transmission. In contrast to the fixed wall controllers 32 and 34, the remote control 36 may be carried by the user and allows operation of the lamps 12 from different places, offering a user more flexibility in controlling lamps 12. A user can thus either use the wall controllers 32 and 34 or the remote control 36 to manage the settings of lamps 12. When an area or scene setting is enabled with the lighting control system 10, lamps 12 are turned on. However, when the user wants to turn a particular lamp off, the user must either search for the remote controller 36 or walk to a wall controller 32 or 34. However, it is cumbersome and not intuitive to change the whole scene in this way.

Therefore, the lighting control system 10 also comprises soft switches 22 and 24, which are either integrated in single lamps 12 or devices comprising groups of lamps 26 or 28, or at least arranged close to the lamps or groups of lamps 26 or 28. The soft switches 22 and 24 may be an integral part of the lamps 12 or implemented as separate devices, which may be installed close to or at a lamp 12 or group of lamps 26 or 28, for example switched between a power line and the lamp or the group of lamps, thus serving as a kind of local control device for a lamp or group of lamps. The soft switches 22 and 24 are implemented as local luminaire control devices, which are able to detect a user touch and to generate a corresponding control signal 16 or 18, which is then sent out with a radio communication module 30 or 32, respectively, being integrated in the soft switches 22 or 24, respectively. The radio communication module 30 or 32, respectively, may be for example a Zigbee or Z-wave device. The dimmer 14 of the lighting system 10 also contains a radio communication module in order to receive control signals 16 and 18 from soft switches 22 and 24. Thus, the soft switches 22 and 24 are integrated in the lighting control system 10 and offer a user, next to the wall controllers 32 and 34 and the remote control 36 the possibility of controlling lamps locally without introducing an additional device, which is not integrated in the lighting control system 10 such as hard switches integrated in the lamp.

To each of the soft switches 22 and 24, a group of lamps 26 or 28, respectively, is assigned. Since the soft switch serves as local control device for a group of lamps, it is typically assigned to lamps, which are in close proximity of the soft switch, or it is integrated in a lamp of the group of lamps. Thus, in contrast to the remote control 36, which allows a user usually to control each lamp 12 of the lighting system 10 and is, therefore, often for users too complicated and complex to operate, a soft switch only allows to locally control certain lamps, for example the lamps in the entrance of a hotel lobby, the lamps installed in a shopping window, or the lamps installed for illuminating a certain wall in a room. The assignment of group of lamps to a soft switch may either be programmed in a soft switch, or in a dimmer, controlling the group of lamps. Both implementations are described in detail in the following.

In a first embodiment, the assignment of lamps or a group of lamps to a soft switch may be programmed in the soft switch itself. The assignment may be transmitted in the control signal, which is sent out by the soft switch upon detection of a user touch. The dimmer, which receives the control signal, may then easily determine which lamps or which group of lamps should be controlled. For example, when the soft switch 22 is touched by a user, it may generate and send out a control signal 16 containing an identification of group 26 of the lamps, to which the soft switch 22 is programmatically assigned. The dimmer 14 receives the control signal 16, determines from the received signal 16 that the group 26 must be for example powered off and switches off the lamps 12 of the group 26. The signal sent out by the soft switch may also contain an identification of the dimmer 14, to which it is addressed. This is helpful when a lighting system comprises a lot of dimmers, since each dimmer receiving the control signal may immediately detect, whether it is addressed or not.

In a second embodiment, the assignment of lamps or group of lamps to a soft switch may be programmed also in the dimmer, which controls the lamps or group of lamps. Thus, a soft switch may only send out a control signal for dimming the lamps, to which is assigned, without containing the assignment, but containing the identification of the sending soft switch. Each dimmer, which receives the control signal, can then determine the sending soft switch. Also, each dimmer contains a list of soft switches, which are assigned to lamps controlled by the respective dimmer. Thus, a dimmer receiving a control signal, determines from the received control signal the sending soft switch and whether the soft switch is contained in its list. If the sending soft switch is contained in its internal soft switch list, the dimmer may then load the assignment of lamps to the sending soft switch and control the lamps as initiated with the received control signal. Since no assignment is send from the soft switch to the controller, the transmitted data is not as large as if the assignment would be transmitted. This requires less transmission capacity. Also, the transmission usually may be performed in a shorter time. However, the assignment must be stored in the dimmer, which requires storage means in the dimmer.

Each soft switch 22 and 24 comprises a touch dimmer interface, which is either based on capacitance or leakage current measurement. The measurement electronic is integrated in each soft switch. Furthermore, a microcontroller is integrated in each soft switch, which executes a program for processing the measurements in the following way: when a user touches the touch dimmer interface of a soft switch, a capacitance change or leakage current is measured. The measurements are digitized and processed by the program executed by the microcontroller such that the touching of the touch dimmer interface results in looping through the states ON-75% dimming-50% dimming-25% dimming-OFF. This is accomplished by switching automatically in the different dimming modes after certain periods. For example, when a leakage current is measured for 1 second, the algorithm of the program switches in the 75% dimming mode, after 2 seconds in the 50% dimming mode and so on. Alternatively, the switching from one dimming mode in another one can be preformed upon each user touch. In order to switch the luminaire in the user desired dimming mode, a control signal representing the present dimming mode is generated and sent out by the radio communication module 30 or 32, respectively, for example as a RF signal compliant with the Z-Wave or ZigBee standard. The sent out control signal 16 or 18 may be also transmitted over a wired communication link to the dimmer 14, for example as a DALI signal over a DALI-bus. The electronic of each soft switch 22 and 24 is fed from the mains or control wires (if the soft switches are wired with the further devices of the lighting control system 10), so that batteries are not required.

The soft switches 22 and 24 may be integrated in lamps. Thus, part of the lamp can be made of metal to sense the touch of a user by measuring a tiny leakage current. Alternatively, a metal plate may be mounted under the (plastic) housing of a lamp. The change in capacitance, when the lamp is touched, could then trigger the sending out of a control signal to the dimmer. The soft switch may be seamlessly integrated in the design of a lamp and does not require (ugly) buttons, knobs or switches.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. An area based lighting control system, comprising
several lamps provided for illuminating an area,
a control device for controlling one or more of the several lamps responsive to received control signals, and
at least one soft switch assigned to one or more lamps and being adapted to sense user touches and to signal sensed user touches by means of sending a control signal to the control device, which is configured to control the lamps, to which the soft switch is assigned, responsive to the received control signal.

2. The system of claim 1, wherein the soft switch comprises a touch dimmer interface integrated in a lamp or implemented as further control device of the system.

3. The system of claim 1, wherein the soft switch comprises a communication device for a wired and/or wireless communication with the control device.

4. The system of claim 1, wherein the control signal sent by the soft switch contains an identification of the soft switch, which sent out the control signal, in order to allow the receiving control device to identify the sending soft switch.

5. The system of claim 1, wherein the control signal sent by the soft switch contains an identification of the control device, to which the control signal is sent.

6. The system of claim 1, wherein the control signal sent by the soft switch contains a dimming value of the lamps being assigned to the soft switch.

7. The system of claim 1, wherein the assignment of lamps to a soft switch is programmed in the soft switch and/or in a control device.

8. A lamp being adapted for usage with a system of claim 1 and comprising a soft switch being assigned to the lamp.

9. The lamp of claim 8, wherein at least a part of the lamp comprises metal, forming a touch-sensitive part of the soft switch.

10. The lamp of claim 9, comprising an integrated electronic unit which is adapted to measure a leak current, which flows during a user touch of the touch sensitive part, and to generate and send out a control signal, when the measured leak current exceeds a predetermined threshold.

11. The lamp of claim 9, comprising an integrated electronic unit which is adapted to measure the capacitance of the touch sensitive part and to generate and send out a control signal, when the measured capacitance exceeds a predetermined threshold.

12-15. (canceled)
